(19) United States
(12) Patent Application Publication
(10) Pub. No.: US 2018/0241272 A1
(43) Pub. Date: Aug. 23, 2018

(54) MOTOR

(71) Applicant: NIDEC CORPORATION, Kyoto (JP)

(72) Inventors: Yu Asahi, Kyoto (JP); Shunsuke Murakami, Kyoto (JP); Takao Atarashi, Kyoto (JP); Masayoshi Maeda, Kyoto (JP)

(21) Appl. No.: 15/751,492

(22) PCT Filed: Aug. 5, 2016
(86) PCT No.: PCT/JP2016/073186

§ 371 Date: Feb. 9, 2018

(30) Foreign Application Priority Data
Aug. 10, 2015 (JP) 2015-158394

(51) Int. Cl. H02K 3/50; H02K 15/00; H02K 3/04

(52) U.S. Cl. CPC H02K 3/50; H02K 3/04; H02K 15/0068

(57) ABSTRACT

A motor includes a rotor including a shaft that is disposed along a central axis extending in an up-down direction; a stator radially facing the rotor with a clearance therebetween and including a plurality of coils; and a busbar electrically connected to the coils. The coils each have a coil end that is an end of a conductive wire. The busbar includes a first conductive member and a second conductive member that serve as different members. The first conductive member has a first coil end connector that is electrically connected to the coil ends. The second conductive member has a second coil end connector that is electrically connected to the coil ends. The plurality of coil ends are sandwiched between the first coil end connector and the second coil end connector and provide electrical continuity between the first coil end connector and the second coil end connector.

### RELATED APPLICATIONS

The present application is a national stage entry according to 35 U.S.C. § 371 of PCT application No.: PCT/JP2016/073186 filed on Aug. 5, 2016, which claims priority from Japanese application No.: 2015-158394 filed on Aug. 10, 2015, is incorporated herein by reference in its entirety.

### FIELD OF THE INVENTION

The present disclosure relates to a motor.

### DESCRIPTION OF THE RELATED ART

Motors with conductive members joined to coil ends have conventionally been known. For example, a conductive member disclosed in Japanese Patent Application Laid-Open No. 2003-324883 includes a strip conductive portion, an arm portion extending from the strip conductive portion, and a hook-shaped coil connecting terminal portion integral with the tip of the arm portion. A coil end is grasped with the arm portion and the coil connecting terminal position and joined to the conductive member by welding or other suitable methods.

In such a motor as described above, the coil end is disposed inside the hook-shaped coil connecting terminal portion and then the coil connecting terminal portion is bent so that the coil end is grasped in contact with the arm portion and the coil connecting terminal portion. Since the arm portion and the coil connecting terminal portion are integral with each other, the coil connecting terminal portion is difficult to bend in the vicinity of the base of the hook, which is the joint between the arm portion and the coil connecting terminal portion. Thus, a clearance may be created between the arm portion and the coil connecting terminal portion.

There are some cases in which a plurality of coil ends are collectively grasped with the arm portion and the coil connecting terminal portion. It is, however, difficult to grasp all the coil ends in contact with the arm portion and the coil connecting terminal portion because a clearance is easily created between the arm portion and the coil connecting terminal portion as described above. For this reason, some of the coil ends may have inappropriate contact with the arm portion and the coil connecting terminal portion, thereby causing joint failure in the welding of the coil ends and the conductive member.

### SUMMARY OF THE INVENTION

A motor according to an aspect of the present disclosure includes a rotor including a shaft that is disposed along a central axis extending in an up-down direction, a stator radially facing the rotor with a clearance therebetween and including a plurality of coils, and a busbar electrically connected to the coils. The coils each have a coil end that is an end of a conductive wire. The busbar includes a first conductive member and a second conductive member that serve as different members. The first conductive member has a first coil end connector that is electrically connected to the coil ends. The second conductive member has a second coil end connector that is electrically connected to the coil ends. The plurality of coil ends are sandwiched between the first coil end connector and the second coil end connector and provide electrical continuity between the first coil end connector and the second coil end connector.

The above and other elements, features, steps, characteristics and advantages of the present discloser will become more apparent from the following detailed description of the preferred embodiments with reference to the attached drawings.

### BRIEF DESCRIPTION OF DRAWINGS

FIG. 1 is a cross-sectional view of a motor according to a preferred embodiment.

FIG. 2 is a perspective view of an upper busbar assembly according to the preferred embodiment.

FIG. 3 is a plan view of the upper busbar assembly according to the preferred embodiment.

FIG. 4 is a perspective view of part of the upper busbar assembly according to the preferred embodiment.

FIG. 5 is a perspective view of part of the upper busbar assembly according to the preferred embodiment.

### DETAILED DESCRIPTION OF THE PREFERRED EMBODIMENTS

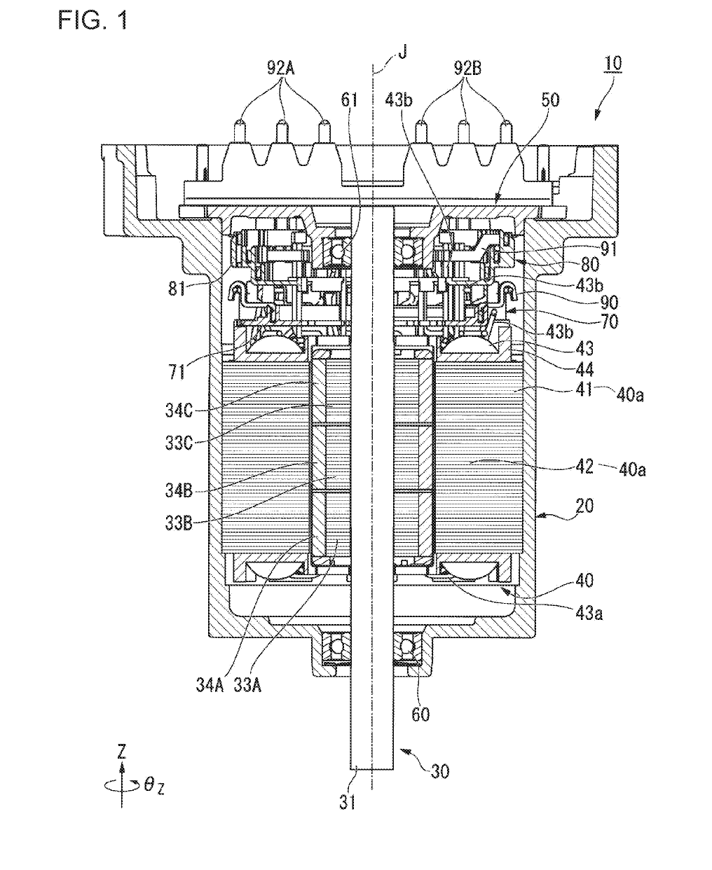

A motor according to a preferred embodiment of the present disclosure will be described hereinafter with reference to the drawings. In the specification of the present invention, the upper side in FIG. 1 in the axial direction of a central axis J that extends in the up-down direction is simply referred to as the “upper side,” and the lower side in FIG. 1 as the “lower side.” The term “up-down direction” as used herein indicates neither positional relationship nor direction at the time when the motor is incorporated in actual equipment. A direction parallel to the central axis J is referred to as the “axial direction,” a radial direction from the central axis J is simply referred to as the “radial direction,” and a circumferential direction around the central axis J is simply referred to as the “circumferential direction.”

The words “extends in the axial direction” as used in the specification of the present invention include not only the case where the object extends strictly in the axial direction, but also cases where the object extends in directions inclined within a range of less than 45 degrees with respect to the axial direction. The words “extends in the radial direction” as used herein include not only the case where the object extends strictly in the radial direction, i.e., in a direction perpendicular to the axial direction, but also cases where the object extends in directions inclined within a range of less than 45 degrees with respect to the radial direction.

As illustrated in FIG. 1, a motor 10 is, for example, an inner rotor type motor. The motor 10 includes a housing 20 capable of housing each part, a rotor 30, a tubular stator 40, a bearing holder 50, a lower bearing 60 held by the housing 20, an upper bearing 61 held by the bearing holder 50, a lower busbar assembly 70, an upper busbar assembly 80, and terminals 92A and 92B.

The rotor 30 includes a shaft 31 disposed along the central axis J, a first rotor core 33A, a second rotor core 33B, a third rotor core 33C, a first magnet 34A, a second magnet 34B, and a third magnet 34C. The lower bearing 60 and the upper bearing 61 support the shaft 31 such that the shaft 31 is rotatable about the central axis J. The rotor 30 is rotatable with respect to the stator 40 inside the stator 40.

The first rotor core 33A, the second rotor core 33B, and the third rotor core 33C have tubular shapes. The first rotor core 33A, the second rotor core 33B, and the third rotor core 33C are arranged in this order in the axial direction from the lower side to the upper side. In the preferred embodiment, the inner side surfaces of the first rotor core 33A, the second rotor core 33B, and the third rotor core 33C have cylindrical shapes around the central axis J. The first rotor core 33A, the second rotor core 33B, and the third rotor core 33C are fitted and fixed to the shaft 31 by press fitting or other suitable methods. Alternatively, the first rotor core 33A, the second rotor core 33B, and the third rotor core 33C may be indirectly fixed to the shaft 31 via other members.

In the preferred embodiment, the first magnet 34A, the second magnet 34B, and the third magnet 34C have plate-like shapes extending in the circumferential direction. The first magnet 34A is fixed to the outer side surface of the first rotor core 33A. The second magnet 34B is fixed to the outer side surface of the second rotor core 33B. The third magnet 34C is fixed to the outer side surface of the third rotor core 33C.

There are a plurality of first magnets 34A, a plurality of second magnets 34B, and a plurality of third magnets 34C, each provided in the circumferential direction. Alternatively, each of the first magnet 34A, the second magnet 34B, and the third magnet 34C may be a single member. In this case, the first magnet 34A, the second magnet 34B, and the third magnet 34C may have a circular ring shape.

The stator 40 radially faces the rotor 30 with a clearance in between. The stator 40 may be disposed radially outward of the rotor 30. In other words, the stator 40 surrounds the rotor 30 circumferentially. The stator 40 includes a stator core 40a, a plurality of coils 43, and a plurality of insulators 44. The stator core 40a may be configured by laminating a plurality of electromagnetic steel sheets. The stator core 40a includes a ring-shaped core back 41 that extends in the circumferential direction, and a plurality of teeth 42 that extends in the radial direction from the core back 41. That is, the stator 40 includes the core back 41 and the teeth 42.

The core back 41 may have a circular ring shape around the central axis J. The outer circumferential surface of the core back 41 may be fixed to the inner circumferential surface of the housing 20 by press fitting or other suitable methods. In the preferred embodiment, the teeth 42 extend radially inward from the inner side surface of the core back 41. The teeth 42 are disposed at equal intervals in the circumferential direction.

The coils 43 consist of conductive wires 43a wound around the teeth 42 via the insulators 44. The coils 43 are disposed respectively on the teeth 42. The coils 43 have coil ends 43b that are ends of the conductive wires 43a. The coil ends 43b extend upward from the portions where the coils 43 are would around the teeth 42. At least parts of the insulators 44 are disposed between the teeth 42 and the coils 43. The insulators 44 cover at least parts of the teeth 42.

The lower busbar assembly 70 has an approximately cylindrical shape. The lower busbar assembly 70 is disposed above the stator 40. The lower busbar assembly 70 includes a neutral busbar 90 and a lower busbar holder 71. That is, the motor 10 includes the neutral busbar 90 and the lower busbar holder 71. The lower busbar holder 71 has an approximately cylindrical shape and holds the neutral busbar 90.

The lower busbar holder 71 may be made of a resin having insulating properties. The lower busbar holder 71 is fixed to the insulators 44. The neutral busbar 90 is electrically connected to the coils 43. To be more specific, the neutral busbar 90 is connected to the coil ends 43b. Thus, the neutral busbar 90 is electrically connected to the stator 40. The neutral busbar 90 serves as a neutral point that connects the plurality of coil ends 43b.

The upper busbar assembly 80 has an approximately cylindrical shape. The upper busbar assembly 80 is disposed above the lower busbar assembly 70. The upper busbar assembly 80 includes a phase busbar 91 and an upper busbar holder 81 that holds the phase busbar 91. That is, the motor 10 includes the phase busbar 91 and the upper busbar holder 81.

The upper busbar holder 81 has an approximately cylindrical shape and may be made of a resin having insulating properties. The upper busbar holder 81 is fixed to the housing 20. The phase busbar 91 is electrically connected to the coils 43. To be more specific, the phase busbar 91 is connected to the coil ends 43b. The phase busbar 91 is connected to the terminals 92A and 92B. Thus, the phase busbar 91 is electrically connected to the stator 40.

The terminals 92A and 92B are plate-like members extending upward. The upper ends of the terminals 92A and 92B are located above the upper edge of the housing 20. The terminals 92A and 92B are connected to external power sources (not shown).

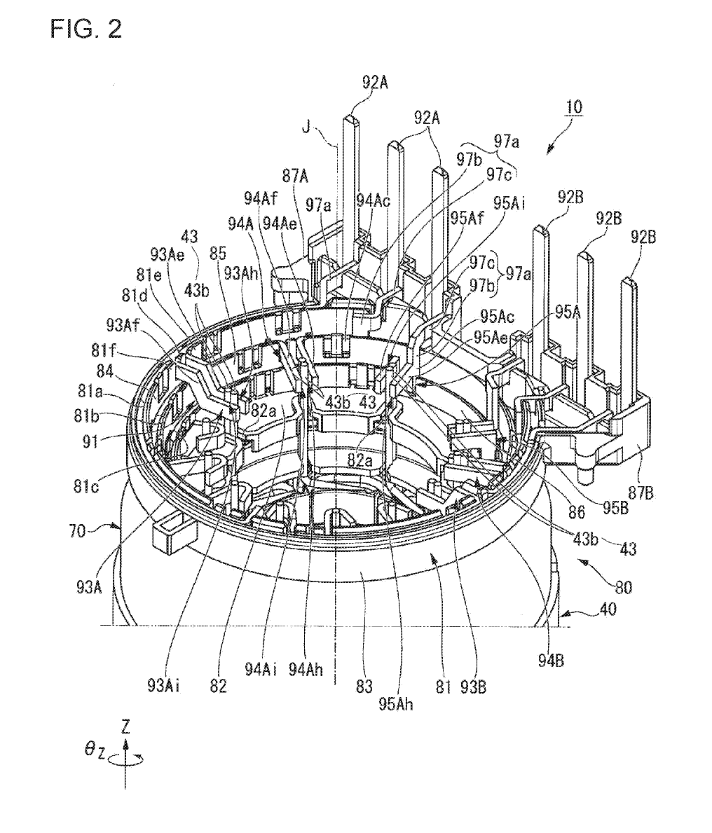

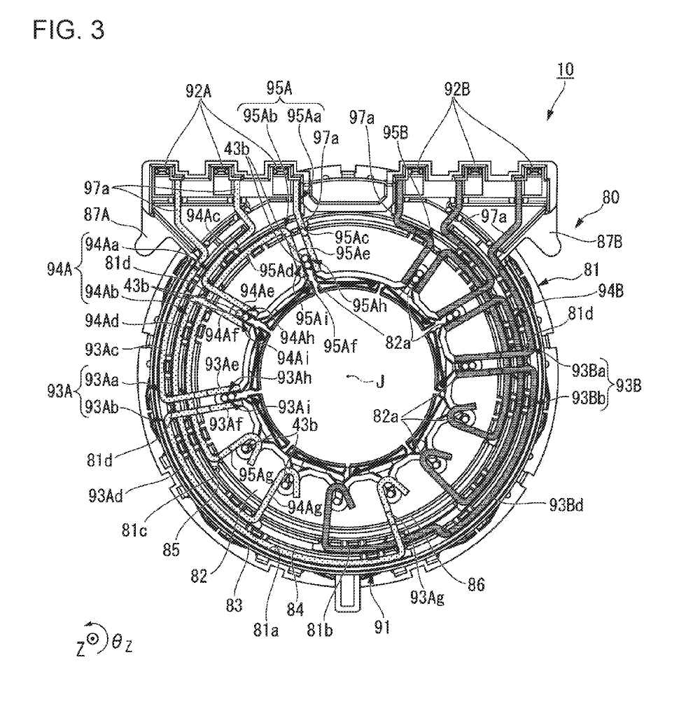

As illustrated in FIGS. 2 and 3, the upper busbar holder 81 has a generally circular ring-shaped second coil support 82, a cylindrical outer cylinder portion 83, a first circumferential wall 84, a second circumferential wall 85, a third circumferential wall 86, and terminal holders 87A and 87B. The motor 10 includes the second coil support 82 having insulating properties.

The outer cylinder portion 83 extends upward from the outer edge of the second coil support 82. The first circumferential wall 84, the second circumferential wall 85, and the third circumferential wall 86 are located radially inward of the outer cylinder portion 83 and extend upward from the second coil support 82. The terminal holders 87A and 87B protrude radially outward from the outer cylinder portion 83.

The central axis J may pass through the center of the second coil support 82. The second coil support 82 has second supporters 82a that support the coil ends 43b. The second coil support 82 is located between the neutral busbar 90 and the phase busbar 91 in the axial direction. Thus, the neutral busbar 90 and the phase busbar 91 can be disposed separately in the up-down direction, with the second coil support 82 sandwiched in between. This allows the coil ends 43b to be easily disposed at predetermined positions during the assembly of the motor.

The second supporters 82a are recessed portions that are recessed radially outward from the inner edge of the second coil support 82. The coil ends 43b pass through the inside of the second supporters 82a. The coil ends 43b are supported from both circumferential sides by the inner side surfaces of the second supporters 82a.

The outer cylinder portion 83 is centered on the central axis J. In the preferred embodiment, the outer cylinder portion 83 has a cylindrical shape around the central axis J. The first circumferential wall 84, the second circumferential wall 85, and the third circumferential wall 86 extend in the circumferential direction. The first circumferential wall 84 has an arc shape in plan view. The second circumferential wall 85 and the third circumferential wall 86 have cylindrical shapes concentric with the outer cylinder portion 83. The second circumferential wall 85 is located radially inward of the first circumferential wall 84. The third circumferential wall 86 is located radially inward of the second circumferential wall 85.

The upper edge of the first circumferential wall 84 is at approximately the same position as the upper edge of the outer cylinder portion 83 in the axial direction. The upper edge of the second circumferential wall 85 is located below the upper edge of the first circumferential wall 84 in the axial direction. The upper edge of the third circumferential wall 86 is located below the upper edge of the second circumferential wall 85 in the axial direction.

The upper busbar holder 81 has a first groove 81a, a second groove 81b, and a third groove 81c that are recessed downward and extend in the circumferential direction. The first groove 81a is located between the outer cylinder portion 83 and the first circumferential wall 84 in the radial direction. The second groove 81b is located between the first circumferential wall 84 and the second circumferential wall 85 in the radial direction. The third groove 81c is located between the second circumferential wall 85 and the third circumferential wall 86 in the radial direction.

The bottom of the first groove 81a is located above the bottom of the second groove 81b in the axial direction. The bottom of the second groove 81b is located above the bottom of the third groove 81c in the axial direction.

The terminal holders 87A and 87B have an approximately rectangular shape in plan view. The terminal holder 87A holds the terminals 92A. The terminal holder 87B holds the terminals 92B.

As illustrated in FIG. 2, the phase busbar 91 includes first phase busbars 93A and 93B, second phase busbars 94A and 94B, and third phase busbars 95A and 95B. That is, the motor 10 includes a plurality of phase busbars 91.

The first phase busbars 93A and 93B are held in the first groove 81a. The second phase busbars 94A and 94B are held in the second groove 81b. The third phase busbars 95A and 95B are held in the third groove 81c.

The plurality of phase busbars 91 constitute a plurality of busbar groups having different connection systems. In the preferred embodiment, the phase busbars 91 constitute two busbar groups, namely a first busbar group that includes the first phase busbar 93A, the second phase busbar 94A, and the third phase busbar 95A, and a second busbar group that includes the first phase busbar 93B, the second phase busbar 94B, and the third phase busbar 95B.

In the following description, the connection system including the first busbar group may be referred to as a “connection system A,” and the connection system including the second busbar group may be referred to as a “connection system B.”

The words “objects have different connection systems” as used in the specification of the present invention include cases where they are electrically connected to different external power sources, and power is supplied independently for each connection system. For example when there are two connection systems A and B, the motor 10 is provided with two external power sources for supplying power, namely the one electrically connected to the connection system A and the one electrically connected to the connection system B.

The two external power sources are capable of supplying power to the motor 10 independently. Even if one of the external power sources that supplies power to one of the connection systems is incapable of supplying power to the motor 10 for some reason, the other external power source is capable of supplying power to the other connection system. Accordingly, for example, even if power cannot be supplied to one of the connection systems due to a problem in devices such as an external power source or a controller of an external power source, the motor 10 can be rotated by passing a current through the other connection system.

As illustrated in FIG. 3, the first phase busbar 93A includes a first conductive member 93Aa and a second conductive member 93Ab that serve as different members. The first conductive member 93Aa has a first busbar body portion 93Ac and a first busbar bent portion 93Ae.

In the preferred embodiment, the first busbar body portion 93Ac has an arc shape and extends in the circumferential direction. The first busbar bent portion 93Ae extends radially inward from the first busbar body portion 93Ac. In the preferred embodiment, the first busbar bent portion 93Ae has a plate-like shape with surfaces parallel to the axial direction. The first busbar bent portion 93Ae is bent and extends from one circumferential end of the first busbar body portion 93Ac. The first busbar body portion 93Ac and the first busbar bent portion 93Ae can be created by bending a long narrow plate-like member. Thus, the first conductive member 93Aa can be manufactured with ease. Note that the shape of the first busbar body portion 93Ac does not necessarily have to be an arc shape.

The second conductive member 93Ab has a second busbar body portion 93Ad, a second busbar bent portion 93Af, and a third busbar bent portion 93Ag. The second busbar body portion 93Ad has an arc shape and extends in the circumferential direction. The second busbar body portion 93Ad is aligned with the first busbar body portion 93Ac in the circumferential direction. The second busbar body portion 93Ad is disposed on one circumferential side of the first busbar body portion 93Ac.

The second busbar bent portion 93Af has a plate-like shape with surfaces parallel to the axial direction. The second busbar bent portion 93Af extends radially inward from the second busbar body portion 93Ad. The second busbar bent portion 93Af is bent and extends from an end of the first busbar body portion 93Ac in a circumferential direction of the second busbar body portion 93Ad. The second busbar body portion 93Ad and the second busbar bent portion 93Af can be manufactured with ease by bending a long narrow plate-like member.

The third busbar bent portion 93Ag has a plate-like shape with surfaces parallel to the axial direction. The third busbar bent portion 93Ag is bent and extends from the circumferential end of the second busbar body portion 93Ad on the side opposite the first busbar body portion 93A. The third busbar bent portion 93Ag extends radially inward from the second busbar body portion 93Ad.

In the preferred embodiment, the third busbar bent portion 93Ag has a hook-shaped tip. In other words, at least part of the tip of the third busbar bent portion 93Ag is curved. The third busbar bent portion 93Ag grasps one coil end 43b. The third busbar bent portion 93Ag is joined to the one coil end 43b by welding or other suitable methods.

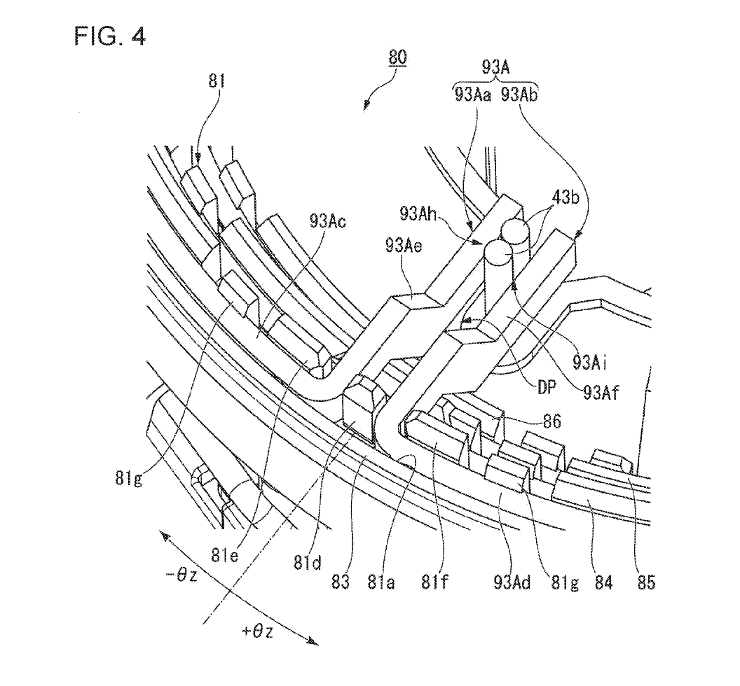

As illustrated in FIG. 4, the first busbar bent portion 93Ae has a first coil end connector 93Ah that is electrically connected to coil ends 43b. That is, the first conductive member 93Aa includes the first coil end connector 93Ah. The second busbar bent portion 93Af has a second coil end connector 93Ai that is electrically connected to coil ends 43b. That is, the second conductive member 93Ab includes the second coil end connector 93Ai.

A plurality of coil ends 43b are sandwiched between the first coil end connector 93Ah and the second coil end connector 93Ai. These coil ends 43b provide electrical continuity between the first coil end connector 93Ah and the second coil end connector 93Ai.

Since the first conductive member 93Aa and the second conductive member 93Ab serving as different members sandwich a plurality of coil ends 43b, there is no need to bend the conductive members. This suppresses, for example, creation of a clearance between the coil ends 43b and a busbar due to insufficient bending of the conductive members. The elimination of a clearance prevents some coil ends 43b from failing to come in contact with the first conductive member 93Aa and the second conductive member 93Ab when the first conductive member 93Aa and the second conductive member 93Ab grasp a plurality of coil ends 43b. Accordingly, when a plurality of coil ends 43b are joined to the coil end connectors, it is possible to reduce the occurrence of joint failure between the first and second coil end connectors 93Ah and 93Ai and the coil ends 43b.

In FIG. 4, two coil ends 43b are sandwiched between and in contact with the first coil end connector 93Ah and the second coil end connector 93Ai. Note that the number of coil ends 43b to be sandwiched in this way may be three or more. The first coil end connector 93Ah, the second coil end connector 93Ai, and the coil ends 43b may be joined by welding or other suitable methods.

In the case where there are a plurality of connection systems that connect the coil ends 43b and the phase busbars 91, the number of coil ends 43b drawn from the coils 43 tends to increase. Thus, it is preferable that a plurality of coil ends 43b are collectively joined to the coil end connectors. This reduces the space to dispose the coil ends 43b and reduces the number of busbars to be connected to the coil ends 43b. Accordingly, it is possible to reduce the occurrence of joint failure when joining a plurality of coil ends 43b collectively to the coil end connectors. In particular, the occurrence of joint failure can be further reduced in the case where there are a plurality of connection systems that connect the coil ends 43b and the phase busbars 91.

At least part of the first busbar bent portion 93Ae faces at least part of the second busbar bent portion 93Af with a clearance DP in between. Thus, a plurality of coil ends 43b can be sandwiched with ease between the first busbar bent portion 93Ae and the second busbar bent portion 93Af during the manufacture of the motor. This further reduces the occurrence of joint failure between the first and second coil end connectors 93Ah and 93Ai and the coil ends 43b.

More preferably, the first busbar bent portion 93Ae and the second busbar bent portion 93Af extend in parallel with each other. In this case, a plurality of coil ends 43b can be sandwiched more easily between the first busbar bent portion 93Ae and the second busbar bent portion 93Af during the manufacture of the motor. Note that the first busbar bent portion 93Ae and the second busbar bent portion 93Af do not necessarily have to extend in parallel with each other.

As illustrated in FIG. 3, the first busbar body portion 93Ac and the second busbar body portion 93Ad are disposed in the first groove 81a. Thus, the upper busbar holder 81 can stably hold the first busbar body portion 93Ac and the second busbar body portion 93Ad. This suppresses a shift in the relative positions of the first coil end connector 93Ah and the second coil end connector 93Ai when the coil ends 43 are joined to the first coil end connector 93Ah and the second coil end connector 93Ai.

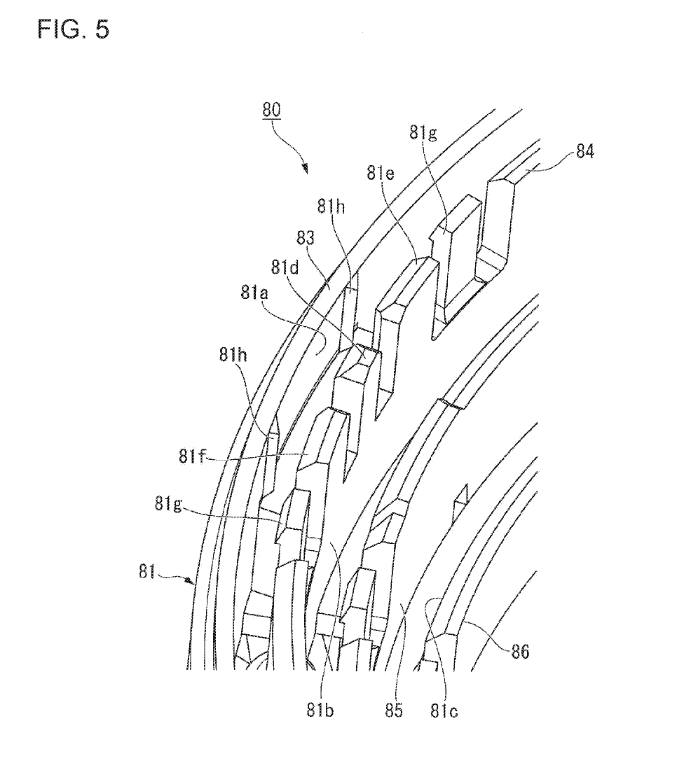

The first busbar body portion 93Ac and the second busbar body portion 93Ad are fitted in the first groove 81a by press fitting or other suitable methods. As illustrated in FIG. 5, the upper busbar holder 81 has a plurality of protrusions 81h that protrude in the radial direction from the inner side surface of the first groove 81a. Although not shown, the first busbar body portion 93Ac and the second busbar body portion 93Ad are engaged in the first groove 81a to come in contact with the protrusions 81h. The phase busbars 91 are not shown in FIG. 5.

The protrusions 81h press the first busbar body portion 93Ac and the second busbar body portion 93Ad in the radial direction. This allows the first busbar body portion 93Ac and the second busbar body portion 93Ad to be more stably held in the first groove 81a. Accordingly, it is possible to further suppress a shift in the relative positions of the first coil end connector 93Ah and the second coil end connector 93Ai when the coil ends 43b are joined to the first coil end connector 93Ah and the second coil end connector 93Ai.

In FIG. 5, the protrusions 81h have a triangular cross-sectional shape orthogonal to the axial direction. The protrusions 81h protrude radially inward from the radially outward one of the inner side surfaces of the first groove 81a. The protrusions 81h extend in the axial direction from the lower edge of the inner side surface of the first groove 81a to the upper edge of the inner side surface of the first groove 81a. Note that the cross-sectional shape of the protrusions 81h, orthogonal to the axial direction, does not necessarily have to be a triangular shape and is not particularly limited, but may be other shapes such as a semicircular shape, a semi-oval shape, or a polygonal shape.

Although not shown, each of the second groove 81b and the third groove 81c also has a plurality of protrusions 81h according to the preferred embodiment. Alternatively, each groove may have only one protrusion 81h. It is sufficient for each of the first busbar body portion 93Ac and the second busbar body portion 93Ad to be in contact with at least one protrusion 81h.

The upper busbar holder 81 has a plurality of claws 81g as illustrated in FIG. 4. The claws 81g protrude radially outward from the first circumferential wall 84. That is, the claws 81g protrude toward the first groove 81a. The claws 81g restrain the upper edge of the first busbar body portion 93Ac and the upper edge of the second busbar body portion 93Ad. The claws 81g secure the first busbar body portion 93Ac and the second busbar body portion 93Ad within the first groove 81a with a snap-fitting structure. This suppresses upward detachment of the first busbar body portion 93Ac and the second busbar body portion 93Ad from the first groove 81a. Accordingly, it is possible to further suppress a shift in the relative positions of the first coil end connector 93Ah and the second coil end connector 93Ai when the coil ends 43b are joined to the first coil end connector 93Ah and the second coil end connector 93Ai.

Although not shown, each of the second circumferential wall 85 and the third circumferential wall 86 also has a plurality of claws 81g according to the preferred embodiment.

The upper busbar holder 81 has a first wall 81d, a second wall 81e, and a third wall 81f. The first wall 81d, the second wall 81e, and the third wall 81f each have a columnar shape protruding upward. The first wall 81d, the second wall 81e, and the third wall 81f are spaced side by side from one another in the circumferential direction.

The first wall 81d is disposed between the first conductive member 93Aa and the second conductive member 93Ab in the circumferential direction. Thus, the circumferential interval between the first conductive member 93Aa and the second conductive member 93Ab can be made greater than or equal to the circumferential dimension of the first wall 81d. This suppresses a reduction in the circumferential clearance between the first busbar bent portion 93Ae and the second busbar bent portion 93Af. Accordingly, the coil ends 43b can be sandwiched with ease between the first coil end connector 93Ah and the second coil end connector 93Ai.

One circumferential end of the first wall 81d is in contact with the first busbar bent portion 93Ae. That is, one circumferential end of the first wall 81d is in contact with the first conductive member 93Aa. The other circumferential end of the first wall 81d is in contact with the second busbar bent portion 93Af. That is, the other circumferential end of the first wall 81d is in contact with the second conductive member 93Ab.

Thus, the circumferential interval between the first conductive member 93Aa and the second conductive member 93Ab can be made equal to the circumferential dimension of the first wall 81d. Accordingly, the coil ends 43b can be sandwiched with ease between the first coil end connector 93Ah and the second coil end connector 93Ai. Note that the circumferential interval between the first conductive member 93Aa and the second conductive member 93Ab may be greater than or equal to the circumferential dimension of the first wall 81d.

The second wall 81e is disposed on one circumferential side of the first wall 81d. The third wall 81f is disposed on the other circumferential side of the first wall 81d. The first busbar bent portion 93Ae is disposed between the first wall 81d and the second wall 81e in the circumferential direction. The second busbar bent portion 93Af is disposed between the first wall 81d and the third wall 81f in the circumferential direction.

The presence of the first wall 81d avoids a situation where the first busbar bent portion 93Ae and the second busbar bent portion 93Af come too close to each other in the circumferential direction, and the presence of the second wall 81e and the third wall 81f avoids a situation where the first busbar bent portion 93Ae and the second busbar bent portion 93Af become too far apart from each other in the circumferential direction. This allows the first busbar bent portion 93Ae and the second busbar bent portion 93Af to have a favorable circumferential interval between them. Accordingly, it is possible to favorably join the coil ends 43b to the first coil end connector 93Ah and the second coil end connector 93Ai by sandwiching the coil ends 43b between the first busbar bent portion 93Ae and the second busbar bent portion 93Af in the circumferential direction during the manufacture of the motor.

The first wall 81d and the second wall 81e circumferentially sandwich the first busbar bent portion 93Ae between and in contact with them. The first wall 81d and the third wall 81f circumferentially sandwich the second busbar bent portion 93Af between and in contact with them.

Thus, the circumferential position of the first busbar bent portion 93Ae can be determined by the first wall 81d and the second wall 81e. The circumferential position of the second busbar bent portion 93Af can be determined by the first wall 81d and the third wall 81f. This allows the first busbar bent portion 93Ae and the second busbar bent portion 93Af to have a favorable circumferential interval between them. Accordingly, it is possible to more favorably join the coil ends 43b to the first coil end connector 93Ah and the second coil end connector 93Ai by sandwiching the coil ends 43b between the second busbar bent portion 93Af and the first busbar bent portion 93Ae in the circumferential direction.

The first wall 81d and the second wall 81e do not necessarily have to be in contact with the first busbar bent portion 93Ae. Only one of the first wall 81d and the second wall 81e may be in contact with the first busbar bent portion 93Ae, or neither of the first wall 81d and the second wall 81e may be in contact with the first busbar bent portion 93Ae. The first wall 81d and the third wall 81f do not necessarily have to be in contact with the second busbar bent portion 93Af. Only one of the first wall 81d and the third wall 81f may be in contact with the second busbar bent portion 93Af, or both of the first wall 81d and the third wall 81f may not be in contact with the second busbar bent portion 93Af.

Even in this case, the first busbar bent portion 93Ae is disposed between the first wall 81d and the second wall 81e, and therefore it is possible to determine the circumferential position of the first busbar bent portion 93Ae. The second busbar bent portion 93Af is also disposed between the first wall 81d and the third wall 81f, and therefore it is possible to determine the circumferential position of the second busbar bent portion 93Af. This allows the first busbar bent portion 93Ae and the second busbar bent portion 93Af to have a favorable circumferential interval between them. Accordingly, it is possible to more favorably join the coil ends 43b to the first coil end connector 93Ah and the second coil end connector 93Ai by sandwiching the coil ends 43b between the first busbar bent portion 93Ae and the second busbar bent portion 93Af in the circumferential direction.

The first wall 81d, the second wall 81e, and the third wall 81f are part of the first circumferential wall 84. In other words, the inner side surface of the first groove 81a includes the first wall 81d, the second wall 81e, and the third wall 81f.

Thus, it is possible to sandwich the bases of the first busbar bent portion 93Ae and the second busbar bent portion 93Af that are connected to their respective busbar body portions. This increases the distances from the portions sandwiched by the first wall 81d, the second wall 81e, and the third wall 81f to the first coil end connector 93Ah and the second coil end connector 93Ai. This eases elastic deformation of the first busbar bent portion 93Ae and the second busbar bent portion 93Af and allows the first coil end connector 93Ah and the second coil end connector 93Ai to easily sandwich the coil ends 43b between them.

As illustrated in FIG. 3, the second phase busbar 94A includes a first conductive member 94Aa and a second conductive member 94Ab. The first conductive member 94Aa and the second conductive member 94Ab serve as different members. The first conductive member 94Aa has a first busbar body portion 94Ac and a first busbar bent portion 94Ae. The second conductive member 94Ab has a second busbar body portion 94Ad, a second busbar bent portion 94Af, and a third busbar bent portion 94Ag.

The third phase busbar 95A includes a first conductive member 95Aa and a second conductive member 95Ab. The first conductive member 95Aa and the second conductive member 95Ab serve as different members. The first conductive member 95Aa has a first busbar body portion 95Ac and a first busbar linear portion 95Ae. The second conductive member 95Ab has a second busbar body portion 95Ad, a second busbar bent portion 95Af, and a third busbar bent portion 95Ag.

The structures of the first busbar body portion 94Ac and the second busbar body portion 94Ad are similar to those of the first busbar body portion 93Ac and the second busbar body portion 93Ad, except that they are disposed in the second groove 81b.

The first busbar body portion 95Ac extends in the axial direction as illustrated in FIG. 2. The first busbar body portion 95Ac is disposed in the third groove 81c. The structure of the second busbar body portion 95Ad is similar to that of the second busbar body portion 93Ad, except that it is disposed in the third groove 81c.

As described above, the bottom of the first groove 81a, the bottom of the second groove 81b, and the bottom of the third groove 81c have different axial positions. Thus, each busbar body portion disposed in each groove also has a different axial position.

Specifically, the first busbar body portion 94Ac and the second busbar body portion 94Ad are disposed below the first busbar body portion 93Ac and the second busbar body portion 93Ad. The first busbar body portion 94Ac and the second busbar body portion 94Ad are disposed above the first busbar body portion 95Ac and the second busbar body portion 95Ad. That is, the second phase busbar 94A is disposed below the first phase busbar 93A and above the third phase busbar 95A. Thus, the phase busbars 91 can be insulated from one another with ease.

The words “a bus bar is disposed above or below another busbar” as used in the specification of the present invention are not limited to the case where the busbar as a whole is disposed above or below another busbar. The words “a busbar is disposed above or below another busbar” also include cases where the busbar body portion of a busbar is disposed above or below the busbar body portion of another busbar.

The first busbar body portion 94Ac and the second busbar body portion 94Ad are disposed radially inward of the first busbar body portion 93Ac and the second busbar body portion 93Ad. The first busbar body portion 94Ac and the second busbar body portion 94Ad are disposed radially outward of the first busbar body portion 95Ac and the second busbar body portion 95Ad. That is, the second phase busbar 94A is disposed radially inward of the first phase busbar 93A and radially outward of the third phase busbar 95A.

This arrangement allows each phase busbar 91 to be easily disposed from above the upper busbar holder 81. The upper busbar holder 81 has the first groove 81a, the second groove 81b, and the radial direction that are disposed at different radial positions. This simplifies the structure of the upper busbar holder 81, as compared with the case where the phase busbars 91 overlap one another in the axial direction.

In the specification of the present invention, the words “a busbar is disposed radially inward or radially outward of another busbar” are not limited to the case where the busbar as a whole is disposed radially inward or radially outward of another busbar. The words “a busbar is disposed radially inward or radially outward of another busbar” also include cases where the busbar body portion of the busbar is disposed radially inward or radially outward of the busbar body portion of another busbar.

The first busbar bent portion 94Ae includes a first coil end connector 94Ah. The second busbar bent portion 94Af includes a second coil end connector 94Ai.

The first busbar linear portion 95Ae has a plate-like shape with surfaces parallel to the axial direction. The first busbar linear portion 95Ae extends radially inward from the first busbar body portion 95Ac. The first busbar linear portion 95Ae has a first coil end connector 95Ah. The second busbar bent portion 95Af has a second coil end connector 95Ai. The first busbar linear portion 95Ae and the second busbar bent portion 95Af face each other at least in part with a clearance in between. The first busbar linear portion 95Ae and the second busbar bent portion 95Af preferably extend in parallel with each other.

The plurality of phase busbars 91 have their first coil end connectors and their second coil end connectors at the same axial position. To be more specific, the first coil end connector 93Ah and the second coil end connector 93Ai of the first phase busbar 93A, the first coil end connector 94Ah and the second coil end connector 94Ai of the second phase busbar 94A, and the first coil end connector 95Ah and the second coil end connector 95Ai of the third phase busbar 95A are disposed in the same plane perpendicular to the axial direction.

Thus, the axial positions at which the first coil end connectors 93Ah, 94Ah, and 95Ah and the second coil end connectors 93Ai, 94Ai, and 95Ai are joined to the coil ends 43b are the same for each phase busbar 91. Moreover, areas where coatings of the coil ends 43b to be joined to the coil end connectors are removed can be aligned to the same position. This improves workability in the process of joining the coil end connectors and the coil ends 43b during the manufacture of the motor.

The axial position of each coil end connector is the same as the axial positions of the first busbar body portion 94Ac and the second busbar body portion 94Ad. Thus, the first busbar bent portion 94Ae and the second busbar bent portion 94Af extend radially inward and linearly from the first busbar body portion 94Ac and the second busbar body portion 94Ad.

The first busbar bent portion 93Ae and the second busbar bent portion 93Af of the first phase busbar 93A each have an inclined portion that is inclined downward from radially outside to radially inside. Thus, the axial positions of the first coil end connector 93Ah and the second coil end connector 93Ai of the first phase busbar 93A are made the same as the axial positions of the first coil end connector 94Ah and the second coil end connector 94Ai of the second phase busbar 94A.

The first busbar linear portion 95Ae of the third phase busbar 95A is connected to the first busbar body portion 95Ac that extends in the axial direction. The second busbar bent portion 95Af has a portion that extends upward from the second busbar body portion 95Ad. Thus, the axial positions of the first coil end connector 95Ah and the second coil end connector 95Ai are made the same as the axial positions of the first coil end connector 94Ah and the second coil end connector 94Ai of the second phase busbar 94A.

The first conductive members 93Aa, 94Aa, and 95Aa each have a busbar terminal 97a. The busbar terminals 97a are connected to the circumferential ends of the first busbar body portions 93Ac and 94Ac on the side opposite the first busbar bent portions 93Ae and 94Ae and to the upper end of the first busbar body portion 95Ac.

Each busbar terminal 97a has a first extension 97b and a second extension 97c. The first extension 97b extends upward from each first busbar body portion. The second extension 97c extends from the upper end of the first extension 97b to a terminal 92A. The second extension 97c preferably extends in a plane perpendicular to the axial direction. The second extension 97c is held by the terminal holder 87A.

The lower ends of the first extensions 97b are located below the lower ends of the terminals 92A in the axial direction. In other words, the joints between the first busbar body portions and the first extensions 97b are located below the lower ends of the terminals 92A.

Specifically, the lower end of the first extension 97b of the second phase busbar 94A and the lower end of the first extension 97b of the third phase busbar 95A are located below the lower ends of the terminals 92A. In this case, if the first extensions extend to the terminals 92A in a plane perpendicular to the axial direction, the axial dimension of the terminal holder 87A, which holds the terminals 92A, will increase.

However, the first extensions 97b according to the preferred embodiment extend upward from the first busbar body portions. Thus, the axial positions of the second extensions 97c that extend in a plane perpendicular to the axial direction can be made close to the axial positions of the terminals 92A. This suppresses an increase in the axial dimension of the terminal holder 87A.

Note that the lower end of the first extension 97b of the first phase busbar 93A is located at approximately the same position as the lower ends of the terminals 92A in the axial direction.

The upper ends of the first extensions 97b are located at approximately the same level as or above the lower ends of the terminals 92A in the axial direction. Thus, the axial positions of the second extensions 97c can be made the same as or above the axial positions of the lower ends of the terminals 92A. This further suppresses an increase in the axial dimension of the terminal holder 87A.

The other configurations of the second phase busbar 94A and the third phase busbar 95A are the same as the configuration of the first phase busbar 93A.

The first phase busbar 93B in the second busbar group has a first conductive member 93Ba and a second conductive member 93Bb. The first conductive member 93Ba is similar to the first conductive member 93Aa of the first phase busbar 93A in the first busbar group.

The second conductive member 93Bb has a second busbar body portion 93Bd. One circumferential portion of the second busbar body portion 93Bd is disposed in the second groove 81b. The other circumferential portion of the second busbar body portion 93Bd is disposed in the first groove 81a. That is, a single busbar body portion of the phase busbar 91 spans two or more grooves. This allows effective use of the space where the phase busbars 91 are arranged in the upper busbar holder 81 and allows the phase busbars 91 to be easily isolated from one another.

The portion of the second busbar body portion 93Bd that is disposed in the second groove 81b is located below the portion thereof that is disposed in the first groove 81a.

The present disclosure is not limited to the above-described preferred embodiments, and other configurations are also applicable. For example, there are no particular limitations on the shapes of the first conductive member 93Aa and the second conductive member 93Ab, as long as the first conductive member 93Aa and the second conductive member 93Ab serve as different members.

As long as at least one of the coil end connectors to which the coil ends 43b are collectively joined is configured to be sandwiched between and connected to the first conductive member and the second conductive member, the other coil end connectors may be configured by a single member. In this case, the coil end connectors configured by a single member may have a hook shape, like the third busbar bent portion 93Ag.

The number of connection systems in the configuration may be one, or may be three or more.

The busbars that apply the configuration of the present disclosure are not limited to phase busbars, and may, for example, be neutral busbars.

The number of rotor cores in the rotor 30 may be one. The motor 10 may, for example, be an outer rotor type motor.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A motor comprising:
a rotor including a shaft that is disposed along a central axis extending in an up-down direction;
a stator radially facing the rotor with a clearance therebetween and including a plurality of coils; and
a busbar electrically connected to the coils,
wherein the coils each have a coil end that is an end of a conductive wire,
the busbar includes a first conductive member and a second conductive member that serve as different members,
the first conductive member has a first coil end connector that is electrically connected to the coil ends,
the second conductive member has a second coil end connector that is electrically connected to the coil ends, and
the plurality of coil ends are sandwiched between the first coil end connector and the second coil end connector and provide electrical continuity between the first coil end connector and the second coil end connector.

2. The motor according to claim 1, wherein
the first conductive member has a first busbar body portion that extends in a circumferential direction, and a first busbar bent portion that is bent and extends from a circumferential end of the first busbar body portion,
the second conductive member has a second busbar body portion that extends in the circumferential direction and that is aligned with the first busbar body portion in the circumferential direction, and a second busbar bent portion that is bent and extends from an end of the first busbar body portion in a circumferential direction of the second busbar body portion,
the first busbar bent portion has the first coil end connector,
the second busbar bent portion has the second coil end connector, and
the first busbar bent portion and the second busbar bent portion face each other at least in part with a clearance therebetween.

3. The motor according to claim 2, further comprising:
a busbar holder that holds the busbar,
wherein the busbar holder has a groove that is recessed downward and extends in the circumferential direction, and
the first busbar body portion and the second busbar body portion are disposed in the groove.

4. The motor according to claim 3, wherein
the busbar holder has a groove that is recessed downward and extends in the circumferential direction, and a plurality of protrusions that protrude radially from an inner side surface of the groove, and
the first busbar body portion and the second busbar body portion are in contact with the protrusions.

5. The motor according to claim 3, wherein
the busbar holder includes a plurality of claws that restrain an upper edge of the first busbar body portion and an upper edge of the second busbar body portion, respectively.

6. The motor according to claim 3, wherein
the busbar holder has a first wall disposed between the first conductive member and the second conductive member in the circumferential direction.

7. The motor according to claim 6, wherein
the busbar holder has a second wall disposed on one circumferential side of the first wall and a third wall disposed on the other circumferential side of the first wall,
the first busbar bent portion is disposed between the first wall and the second wall in the circumferential direction, and
the second busbar bent portion is disposed between the first wall and the third wall in the circumferential direction.

8. The motor according to claim 7, wherein
an inner side surface of the groove includes the first wall, the second wall, and the third wall.

9. The motor according to claim 2, wherein
the busbar includes a first busbar, a second busbar, and a third busbar,
the second busbar is disposed below the first busbar and above the third busbar.

10. The motor according to claim 9, wherein
the second busbar is disposed radially inward than the first busbar and radially outward than the third busbar.

11. The motor according to claim 9, wherein
the first coil end connector and the second coil end connector of the first busbar, the first coil end connector and the second coil end connector of the second busbar, and the first coil end connector and the second coil end connector of the third busbar are disposed in the same plane perpendicular to a direction of the axis.

12. The motor according to claim 9, comprising:
a terminal connected to a power source,
wherein the busbar is a phase busbar that includes a busbar terminal connected to the terminal,
the busbar terminal includes a first extension that extends upward from the first busbar body portion and a second extension that extends from an upper end of the first extension to the terminal, and
a lower end of the first extension is located below a lower end of the terminal in the axial direction.

13. The motor according to claim 9, wherein
a plurality of the busbars constitute a plurality of connection systems.
